(19) United States
(12) Patent Application Publication
(10) Pub. No.: US 2006/0067783 A1
(43) Pub. Date: Mar. 30, 2006

(54) Dual chamber applicator

(76) Inventor: Garry Tsaur, Rowland Heights, CA (US)

Correspondence Address: JOE NIEH, 18760 E. AMAR ROAD #204, WALNUT, CA, 91789, US

(21) Appl. No.: 10/949,529

(22) Filed: Sep. 25, 2004

(51) Int. Cl. B05C 1/00; B43K 5/14

(52) U.S. Cl. 401/132; 401/17; 401/18

(57) ABSTRACT

An applicator with two chambers wherein each chamber may contain a substance such as a liquid in the chamber. The substance in the two chambers may be the same substance or different substances. The dual chamber applicator comprises of an elongated housing with two sealed ends. An opening means is disposed between the two sealed ends separating the two sealed ends. A substance such as a liquid is enclosed near each sealed end. After the opening means is operated to open the elongated housing, the opening means will effectively become an applicator for each section of the elongated housing.

### BACKGROUND—FIELD OF INVENTION

The present invention relates generally to an applicator with an enclosed substance such as a fluid. More specifically, the present invention relates to an applicator with two chambers that may contain one or more substances such as a liquid in the chambers.

### BACKGROUND—DESCRIPTION OF RELATED ART

Swab applicator generally comprises of a tubular handle with a formed absorbent tip at one or both ends of the tubular handle. The absorbent tip may be made of cotton or a foam absorbent material. The tubular handle may be made of wood, paper, or plastic and it may be solid or hollow.

Swab applicators have a variety of applications. Swab applicators are a convenient and sanitary means for applying a variety of substances such as liquids, lotions, creams, and various chemicals and medications. Generally the applicator tip of a dry swab applicator is first placed in contact with the liquid to be applied for the applicator tip to absorb the liquid. Subsequently, the moisturized applicator tip is placed in contact with the surface to apply the absorbed liquid to the surface.

Some applications require two separate liquids to be stored separately and mixed just prior to application or applied in sequence. This will generally require the use of two separate swab applicators. If only one swab applicator is used, the swab applicator will have to be first placed in contact with the first liquid and subsequently placed in contact with the second liquid. Using only one swab applicator for the two liquids will result in contamination of the second liquid with the first liquid.

### BRIEF SUMMARY OF THE INVENTION

The present invention is an applicator with two chambers wherein each chamber may contain a substance such as a liquid in the chamber. In one embodiment, the two chambers are separated from each other wherein each chamber may contain a separate substance. The substance in the two chambers may be the same substance or different substances. In another embodiment, the two chambers may have one or more interconnecting channels that allow substance from one chamber to enter into the other chamber.

The dual chamber applicator comprises of an elongated housing with two sealed ends. An opening means is disposed between the two sealed ends separating the two sealed ends. A substance such as a liquid is enclosed near each sealed end. After the opening means is operated to open the elongated housing, the opening means will effectively become an applicator for each section of the elongated housing.

### BRIEF DESCRIPTION OF THE DRAWINGS

FIG. 1 shows the preferred embodiment of the dual chamber applicator.

FIG. 2 shows another embodiment of the dual chamber applicator.

FIG. 3 shows another embodiment of the dual chamber applicator.

FIG. 4 shows another embodiment of the dual chamber applicator.

FIG. 5 shows another embodiment of the dual chamber applicator.

FIG. 6 shows another embodiment of the dual chamber applicator.

FIG. 7 shows another embodiment of the dual chamber applicator.

FIG. 8 shows another embodiment of the dual chamber applicator.

FIG. 9 shows another embodiment of the dual chamber applicator.

FIG. 10 shows another embodiment of the dual chamber applicator.

### DETAILED DESCRIPTION OF THE PREFERRED EMBODIMENT

The following description and figures are meant to be illustrative only and not limiting. Other embodiments of this invention will be apparent to those of ordinary skill in the art in view of this description.

The dual chamber applicator is an applicator with two chambers wherein each chamber may contain a substance such as a liquid in the chamber. In one embodiment, the two chambers are separated from each other wherein each chamber may contain a separate substance. The substance in the two chambers may be the same substance or different substances. In another embodiment, the two chambers may have one or more interconnecting channels that allow substance from one chamber to enter into the other chamber.

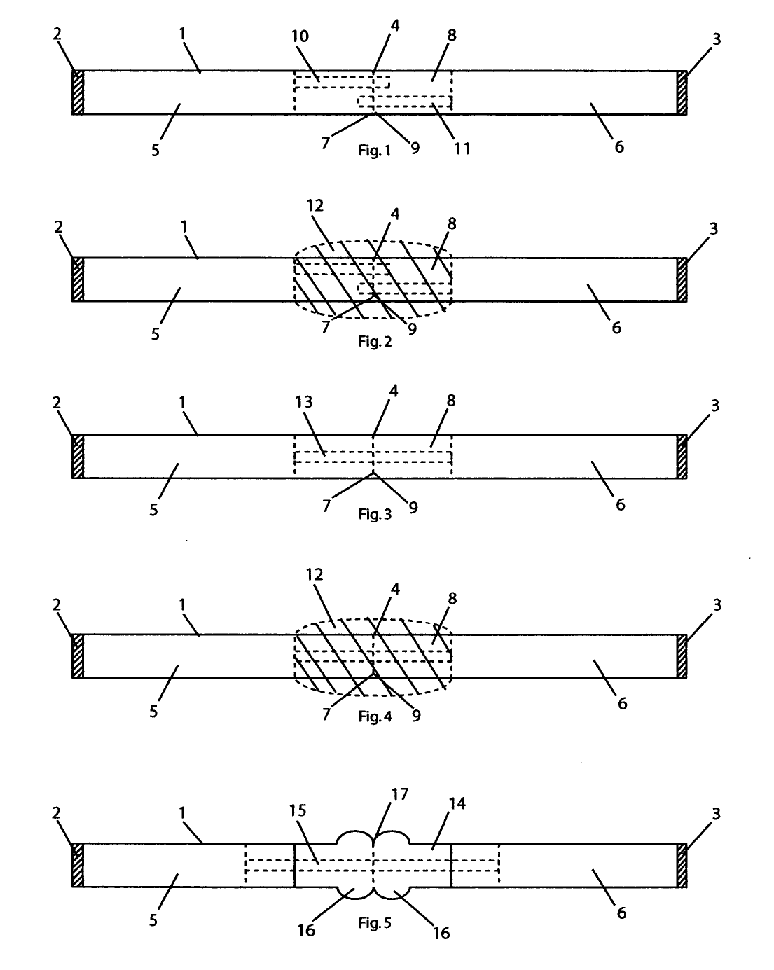

In the preferred embodiment, the dual chamber applicator comprises of an elongated housing 1 with two sealed ends 2, 3 as shown in FIG. 1. The elongated housing 1 is preferably made of plastic such as polypropylene or polyethylene. The elongated housing 1 may be rigid or flexible. An opening means 4 is disposed between the two sealed ends 2, 3 separating the two sealed ends 2, 3 and defining two separate chambers 5, 6. The opening means 4 is preferably a fracture line 7 that will enable the elongated housing 1 to break open into two sections when it is bent near the fracture line 7.

In the preferred embodiment the opening means 4 comprises of a rigid support section 8 with built-in applicator tips 9 near its mid-section and with a fracture line 7 at the built-in applicator tips 9 affixed between the two sealed ends 2, 3 of the elongated housing 1 to facilitate opening of the elongated housing 1 if the elongated housing 1 is flexible. The rigid support section 8 is fracturable into two parts at a fracture line 7 when it is bent. The rigid support section 8 has one or more holes 10, 11 extending from each end of the rigid support section 8 which extends pass the fracture line 7 without passing through the other end of the rigid support section 8. In this embodiment, the two chambers 5, 6 may each contain a different substance than the other chamber.

Upon bending of the rigid support section 8 it will separate into two sections at the fracture line 7 and one or more fluid flow paths are formed leading from the enclosed substance to the now opened end of the rigid support section 8. The rigid support section 8 with a fracture line 7 at the built-in applicator tips 9 will break open at the fracture line 7 and becomes an applicator tip for each of the sections of the elongated housing 1. When a rigid support section 8 with a fracture line 7 at the built-in applicator tips 9 is utilized, the elongated housing 1 may be fabricated in two sections that are affixed to the two ends of the rigid support section 8. A substance such as a liquid, cream, or a powder may be enclosed in each sealed chamber 5, 6. After the opening means 4 is operated to open the elongated housing 1, the opening means 4 will effectively become an applicator tip for each section of the elongated housing 1 to dispense the substance within each chamber 5, 6. If the elongated housing 1 is flexible, each chamber 5, 6 may be compressed to force its contents out through the applicator tip 9.

As shown in FIG. 2, the opening means 4 may be further surrounded by an absorbent material 12 such as cotton, foam, or sponge wherein after the opening means 4 is operated to release the contents of the elongated housing 1, the contents will be released into the absorbent material 12 for application. The absorbent material 12 may also contain a substance such as a powder in it wherein the substance may commingle with the content of the elongated housing 1. The elongated housing 1 may be bent so that the sealed ends 2, 3 of the elongated housing 1 are adjacent to each other resulting in an applicator that is approximately half the length of the elongated housing 1. The applicator with the content released into the absorbent material 12 may then be used to apply the content to the desired location.

FIG. 3 shows another embodiment of the dual chamber applicator. In this embodiment, the rigid support section 8 has one or more through hole 13 that extends from one end through the other end of the rigid support section 8. Upon bending of the rigid support section 8 it will separate into two sections at the fracture line 7 and one or more fluid flow paths are formed leading from the enclosed substance to the now opened end of the rigid support section 8. The rigid support section 8 with a fracture line 7 at the built-in applicator tip 9 will break open at the fracture line 7 and becomes an applicator tip 9 for each of the sections of the elongated housing 1.

As shown in FIG. 4, the opening means 4 may be further surrounded by an absorbent material 12 such as cotton, foam, or sponge wherein after the opening means 4 is operated to release the contents of the elongated housing 1, the contents will be released into the absorbent material 12 for application. The absorbent material 12 may also contain a substance such as a powder in it wherein the substance may commingle with the content of the elongated housing 1. The elongated housing 1 may be bent so that the sealed ends 2, 3 of the elongated housing 1 are adjacent to each other resulting in an applicator that is approximately half the length of the elongated housing 1. The applicator with the content released into the absorbent material 12 may then be used to apply the content to the desired location.

FIG. 5 shows another embodiment of the dual chamber applicator. In this embodiment, the rigid support section 14 has one or more through hole 15 that extends from one end through the other end of the rigid support section 14. The built-in applicator tips 16 near the mid-section of the rigid support section 14 are in the form of two adjacent spheres affixed together with a fracture line 17 between the two spheres. The rigid support section 14 is fracturable into two parts resulting in two rounded applicator tips 16 at the fracture line 17 when it is bent.

FIG. 6 shows another embodiment of the dual chamber applicator. In this embodiment, the rigid support section 18 has one or more through hole 19 that extends from one end through the other end of the rigid support section 18. The built-in applicator tips 20 near the mid-section of the rigid support section 18 are in the form of a narrowing of the rigid support section 18 near the mid-section with a fracture line 21 at the narrowing. The rigid support section 18 is fracturable into two parts resulting in two narrow applicator tips 20 at the fracture line 21 when it is bent.

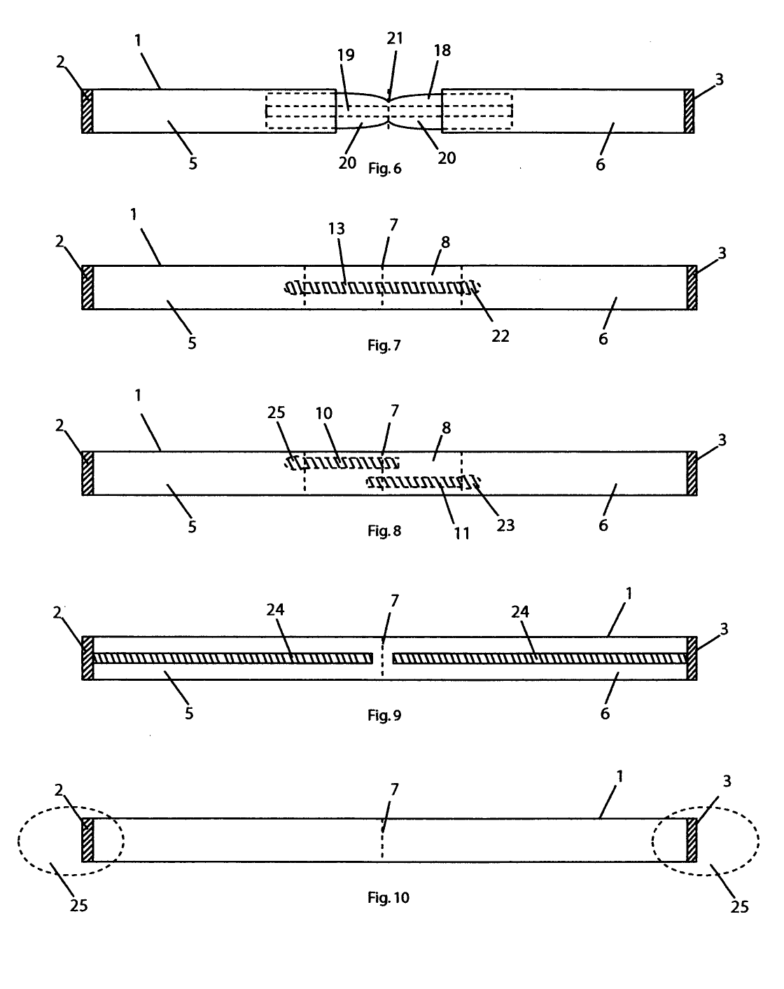

FIG. 7 shows another embodiment of the dual chamber applicator. In this embodiment, the rigid support section 8 has one or more through hole 13 that extends from one end through the other end of the rigid support section 8. In each of the holes 13 is inserted an absorbent material 22 such as cotton, foam, or sponge which may protrude from both ends of the holes 13. Upon bending of the rigid support section 8 it will separate into two sections at the fracture line 7 and one or more fluid flow paths are formed leading from the enclosed substance to the now opened end of the rigid support section 8. The absorbent material 22 will slow the rate of extraction of the substance within the elongated housing and allow application of the substance with the absorbent material 22 in a controlled manner. The rigid support section 8 with a fracture line 7 at the built-in applicator tip will break open at the fracture line 7 and becomes an applicator tip for each of the sections of the elongated housing 1.

FIG. 8 shows another embodiment of the dual chamber applicator. In this embodiment, the rigid support section 8 has one or more holes 10, 11 extending from each end of the rigid support section 8 which extends pass the fracture line 7 without passing through the other end of the rigid support section 8. In this embodiment, the two chambers 5, 6 may each container a different substance than the other chamber. In each of the holes 10, 11 is inserted an absorbent material 23 such as cotton, foam, or sponge which may protrude from the open end of each of the holes 10, 11. Upon bending of the rigid support section 8 it will separate into two sections at the fracture line 7 with a portion of the absorbent material 23 protruding from the fracture surface 7 and one or more fluid flow paths are formed leading from the enclosed substance to the now opened end of the rigid support section 8. The absorbent material 23 will slow the rate of extraction of the substance within the elongated housing 1 and allow application of the substance with the absorbent material 23 in a controlled manner. The rigid support section 8 with a fracture line 7 at the built-in applicator tip will break open at the fracture line 7 and becomes an applicator tip for each of the sections of the elongated housing 1.

FIG. 9 shows another embodiment of the dual chamber applicator. In this embodiment, the dual chamber applicator comprises of an elongated housing 1 with two sealed ends 2, 3. A fracture line 7 is formed between the two sealed ends 2, 3. An elongated member 24 is affixed to each of the sealed ends 2, 3 and extends to near the fracture line 7. Upon bending of the elongated housing 1 near the fracture line 7, the elongated housing 1 will separate into two sections at the fracture line 7. Each separated section of the elongated housing 1 will enclose an elongated member 24 which terminates at or just within the fracture line 7. The elongated members 24 serve to increase the capillarity action of the substance and disrupt the surface tension of the substance within the elongated housing 1 to allow extraction of the enclosed substance without necessitating compressing the elongated housing 1 if the elongated housing 1 has a small diameter. The substance will easily flow out of the elongated housing 1 around the elongated member 24. An absorbent material such as cotton, foam, or sponge may also be affixed to one or both sealed ends 2, 3 to be used as applicators.

FIG. 10 shows another embodiment of the dual chamber applicator. In this embodiment, the dual chamber applicator comprises of an elongated housing 1 with two sealed ends 2, 3. An absorbent material 25 such as cotton, foam, or sponge is affixed to each sealed end 2, 3. The absorbent material 25 may also contain a substance such as a powder in it wherein the substance may commingle with the content of the elongated housing 1. A fracture line 7 is provided between the two sealed ends 2, 3. Upon bending of the elongated housing 1 near the fracture line 7, the elongated housing 1 will separate into two sections at the fracture line 7. The absorbent material 25 in one section of the elongated housing 1 may be used to absorb and apply the substance in the other section of the elongated housing 1 by placing it in physical contact with the substance near the fractured end 7 of the other section.

Although the invention has been described in terms of particular embodiments and applications, one of ordinary skill in the art, in light of this teaching, can generate additional embodiments and modifications without departing from the spirit of or exceeding the scope of the claimed invention. Accordingly, it is to be understood that the drawings and descriptions herein are proffered by way of example to facilitate comprehension of the invention and should not be construed to limit the scope thereof.

What is claimed is:

1. A dual chamber applicator comprising:
an elongated housing with two sealed ends;
an opening means disposed between said two sealed ends of said elongated housing separating said two sealed ends and defining two separate sealed chambers in said elongated housing; and
one or more substance disposed within one or more of said sealed chambers.

2. A dual chamber applicator as in claim 1, wherein said opening means is a fracture line.

3. A dual chamber applicator as in claim 1, wherein said elongated housing is made of plastic.

4. A dual chamber applicator as in claim 3, wherein said elongated housing is made of polypropylene or polyethylene.

5. A dual chamber applicator as in claim 1, wherein said opening means comprises of a rigid support section with two ends and with built-in applicator tips and with a fracture line at said built-in applicator tips and wherein said rigid support section has one or more holes extending from each end of said rigid support section which extends pass the fracture line without passing through the other end of the rigid support section.

6. A dual chamber applicator as in claim 5, wherein said built-in applicator tips are in the form of two adjacent spheres.

7. A dual chamber applicator as in claim 5, wherein said built-in applicator tips are in the form of a narrowing between the two ends of said rigid support section.

8. A dual chamber applicator as in claim 5, wherein an absorbent material is disposed within said holes.

9. A dual chamber applicator as in claim 5, wherein said opening means is surrounded by an absorbent material.

10. A dual chamber applicator as in claim 9, wherein said absorbent material is selected from the group comprising cotton, foam, and sponge.

11. A dual chamber applicator as in claim 1, wherein said opening means comprises of a rigid support section with two ends and with built-in applicator tips and one or more through hole that extends from one end through the other end of said rigid support section and with a fracture line at said built-in applicator tips.

12. A dual chamber applicator as in claim 11, wherein said built-in applicator tips are in the form of two adjacent spheres.

13. A dual chamber applicator as in claim 10, wherein said built-in applicator tips are in the form of a narrowing between the two ends of said rigid support section.

14. A dual chamber applicator as in claim 11, wherein an absorbent material is disposed within one or more of said hole.

15. A dual chamber applicator as in claim 1 1, wherein said opening means is surrounded by an absorbent material.

16. A dual chamber applicator as in claim 15, wherein said absorbent material is selected from the group comprising cotton, foam, and sponge.

17. A dual chamber applicator comprising:
an elongated housing with two sealed ends;
an opening means disposed between said two sealed ends of said elongated housing separating said two sealed ends and defining two separate sealed chambers in said elongated housing;
an elongated member disposed within one or more of said sealed chambers; and
a substance disposed within said sealed chambers.

18. A dual chamber applicator comprising:
an elongated housing with two sealed ends;
an opening means disposed between said two sealed ends of said elongated housing;
a substance disposed within said elongated housing; and
an absorbent material affixed to one or more of said sealed ends.

19. A dual chamber applicator as in claim 18, wherein said absorbent material is selected from the group comprising cotton, foam, and sponge.

20. A dual chamber applicator as in claims 9, 15, or 18, wherein said absorbent material contains a substance in it.
